(19) United States
(12) Patent Application Publication
(10) Pub. No.: US 2023/0058736 A1
(43) Pub. Date: Feb. 23, 2023

(54) CURRENT COLLECTORS WITH A GROUP 6 METAL THEREON AND RELATED ELECTROCHEMICAL CELLS AND METHODS

(71) Applicants: Battelle Energy Alliance, LLC, Idaho Falls, ID (US); The Research Foundation for the State University of New York, Albany, NY (US)

(72) Inventors: Bin Li, Idaho Falls, ID (US); Erik J. Dufek, Ammon, ID (US); Peter G. Khalifah, Upton, NY (US)

(21) Appl. No.: 17/819,993

(22) Filed: Aug. 16, 2022

Related U.S. Application Data
(60) Provisional application No. 63/260,286, filed on Aug. 16, 2021.

(51) Int. Cl. H01M 4/66; H01M 10/0525; H01M 4/62; H01M 4/74; H01M 10/058

(52) U.S. Cl. CPC H01M 4/661; H01M 4/74; H01M 4/625; H01M 4/626; H01M 10/058; H01M 10/0525

(57) ABSTRACT

A current collector is disclosed and comprises a conductive material and an elemental metal of a group 6 metal contacting the conductive material. Also disclosed are an electrochemical cell comprising a current collector, a cathode adjacent to the current collector, and an alkali metal-based electrolyte between the current collector and the cathode, with the cathode separated from the group 6 metal by the alkali metal-based electrolyte. A method of operating the electrochemical cell is also disclosed.

### CROSS-REFERENCE TO RELATED APPLICATION

This application claims the benefit under 35 U.S.C. §119(e) of U.S. Provisional Pat. Application Serial No. 63/260,286, filed Aug. 16, 2021, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure relates generally to electrochemical cells including current collectors. More specifically, the disclosure relates to electrochemical cells that include a current collector, and include a group 6 metal on the current collector.

### BACKGROUND

Lithium-ion batteries are a form of rechargeable battery often used in electric vehicles and a variety of electronics. Lithium (Li) metal is often considered a desirable material for rechargeable battery technology due to its high theoretical capacity and low electrochemical potential. However, rechargeable lithium batteries have not reached their commercial potential due to uneven plating and stripping of lithium metal within the batteries, as well as occurrence of side reactions between lithium metal and electrolytes, which cause the formation of a solid electrolyte interphase (SEI). The heterogeneity resulting from the formation of the SEI causes non-uniform current distribution, which leads to both poor efficiency and safety issues from lithium dendrite growth. Dendrite growth and inactive metallic lithium formation occur over several cycles and may cause poor cycle life and safety issues.

Lithium metal, due to its highly reactive nature, electrochemically or chemically reacts where it contacts the electrolyte. This reaction occurs over the first several charging cycles and forms the SEI. The SEI functions as a passivating layer on the lithium electrode, minimizing the lithium metal from being further consumed by additional reactions with the electrolyte.

Anode-free rechargeable lithium batteries are useful energy storage systems due to their significantly increased energy density and reduced cost. They also benefit from greater ease of assembly because of the absence of an active (e.g., reactive) anode material. However, significant challenges, including lithium dendrite growth and low coulombic efficiency (CE), have impeded their practical implementation.

### BRIEF SUMMARY

A current collector is disclosed and comprises a conductive material and an elemental metal of a group 6 metal contacting the conductive material.

Also disclosed is an electrochemical cell that comprises a current collector comprising a group 6 metal on a conductive material, a cathode adjacent to the current collector, and an alkali metal-based electrolyte between the current collector and the cathode. The cathode is separated from the group 6 metal by the alkali metal-based electrolyte.

A method of operating an electrochemical cell is also disclosed and comprises forming an electrochemical cell comprising a current collector, an alkali metal-based electrolyte on the current collector, and a cathode on the electrolyte. The current collector comprises a conductive material and a group 6 metal thereon. The electrochemical cell is cycled to form the alkali metal on the current collector. The electrochemical cell is discharged to remove the alkali metal from the current collector.

### BRIEF DESCRIPTION OF THE DRAWINGS

While the specification concludes with claims particularly pointing out and distinctly claiming what are regarded as embodiments of the disclosure, various features and advantages of this disclosure may be more readily ascertained from the following description of example embodiments provided with reference to the accompanying drawings, in which:

FIGS. 1A and 1B are schematics illustrating an anode-free electrochemical cell with a current collector in accordance with embodiments of the disclosure;

FIG. 2 shows the specific discharge capacity and columbic efficiencies (CEs) vs. cycle numbers for different electrochemical cells including a lithium anode, a copper current collector, a molybdenum decorated current collector, and a zinc decorated current collector in a first cell setup with a carbonate-based electrolyte used in accordance with embodiments of the disclosure; and

FIG. 3 shows the specific discharge capacity and CEs vs. cycle numbers for different electrochemical cells including a lithium anode, a copper current collector, a molybdenum decorated current collector, and a zinc decorated current collector in a secondary cell setup with an ether-based electrolyte used in accordance with embodiments of the disclosure.

### DETAILED DESCRIPTION

An electrochemical cell including a current collector having a group 6 metal on a conductive material (e.g., an electrically conductive material) is disclosed. The group 6 metal is on a surface of the conductive material of the current collector and functions as a so-called “decoration” on the current collector. The electrochemical cell also includes an electrolyte and a cathode. Energy storage devices (e.g., alkali metal ion batteries) including one or more of the electrochemical cells are also disclosed. The energy storage device (e.g., the alkali metal ion battery) contains one or more electrochemical cells that are free of (e.g., lack) an anode as initially formed, with the conductive material and the group 6 metal functioning as the anode after initial cycling of the electrochemical cell. The electrochemical cell according to embodiments of the disclosure is, therefore, anode-free before the initial cycling of the electrochemical cell is conducted. The conductive material and the group 6 metal of the current collector are positioned at an anode side of the electrochemical cell.

The following description provides specific details, such as material compositions and processing conditions (e.g., temperatures, pressures, flow rates, etc.) in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components are inherently disclosed herein and that adding various conventional process components and acts would be in accord with the disclosure.

As used herein, spatially relative terms, such as "beneath," "below," "lower," "bottom," "above," "upper," "top," "front," "rear," "left," "right," and the like, may be used for ease of description to describe one element’s or feature’s relationship to another element(s) or feature(s) as illustrated in the figure. Unless otherwise specified, the spatially relative terms are intended to encompass different orientations of the materials in addition to the orientation depicted in the figure. For example, if materials in the figure are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, the term “substantially all” means and includes greater than about 95%, such as greater than about 99%.

As used herein, the term “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof.

As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

As used herein, the term “anode” and its grammatical equivalents means and includes an electrode where oxidation takes place during a discharge cycle. Prior to initial cycling of the electrochemical cell, the electrochemical cell according to embodiments of the disclosure may lack an anode.

As used herein, the term “cathode” and its grammatical equivalents means and includes an electrode where reduction takes place during a discharge cycle.

As used herein, the term “electrolyte” and its grammatical equivalents means and includes an ionic conductor, which can be in a solid state, a liquid state, or a gaseous state (e.g., a plasma).

As used herein, the term “elemental metal” and its grammatical equivalents means and includes a metal material containing only atoms of a single type of chemical element. Therefore, atoms of other chemical elements are not present in the elemental metal. The elemental metal exhibits high electrical conductivity, high thermal conductivity, and high ductility. Chemical compounds of the metal are excluded from the definition of an elemental metal.

As used herein, the term “group 6 metal” and its grammatical equivalents means and includes a chromium material, a molybdenum material, a tungsten material, or a material including a combination thereof. Seaborgium is excluded from the definition of a group 6 metal.

As used herein, the term “decorated” and its grammatical equivalents means and includes to be contacted with. The current collector is decorated with the group 6 metal in that the group 6 metal contacts the conductive material of the current collector. The group 6 metal of the current collector may be in the form of a film, a foil, a sheet, a mesh, particles, or other shape.

The illustrations presented herein are not meant to be actual views of any particular electrochemical cell (e.g., alkali metal ion battery), current collector, cathode, or related method, but are merely idealized representations, which are employed to describe example embodiments of the present disclosure. The figures are not necessarily drawn to scale. Additionally, elements common between figures may retain the same numerical designation.

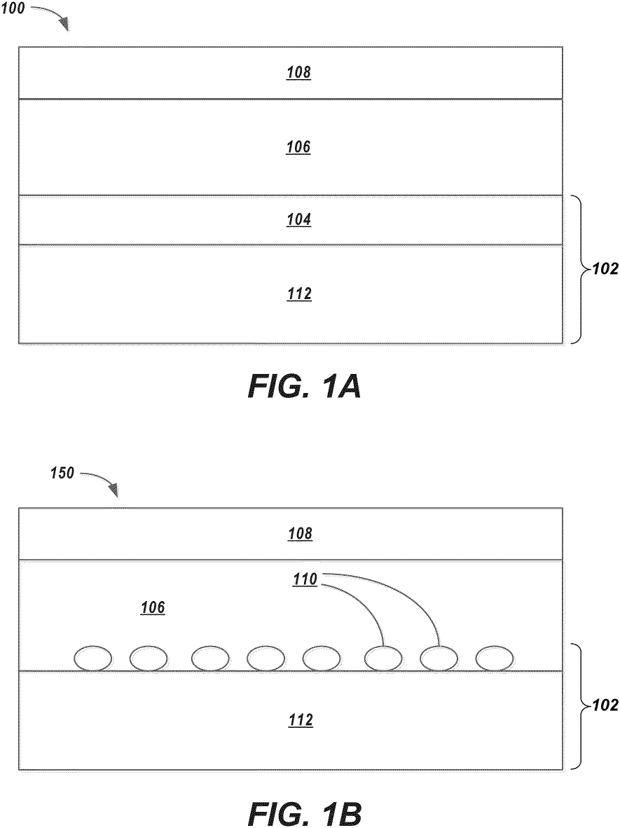

Embodiments of the disclosure will now be described with respect to FIGS. 1A and 1B, which are schematic illustrations of anode-free electrochemical cells 100, 150 in accordance with embodiments of the disclosure. One or more of the electrochemical cells 100, 150 may be included, for example, in the alkali metal ion battery (e.g., a lithium-ion battery, a sodium-ion battery, a potassium-ion battery, a magnesium-ion battery, a calcium-ion battery). The alkali metal ion battery may also include a combination of electrochemical cells 100 and electrochemical cells 150. The electrochemical cell 100, 150 may, for example, be present in a lithium-ion battery. The electrochemical cell 100, 150 includes a current collector 102, a cathode 108, and an electrolyte 106. The current collector 102 includes a group 6 metal 104 on a surface of a conductive material 112 (e.g., an electrically conductive material 112), decorating the current collector 102 with the group 6 metal 104. The group 6 metal 104 may be in the form of a film, a foil, a sheet, a mesh, particles, or other shapes. As shown in FIG. 1A, the group 6 metal 104 is present as a substantially continuous layer on the conductive material 112. The substantially continuous layer may, for example, be configured as a foil or a film of the group 6 metal 104. As shown in FIG. 1B, the group 6 metal 104 is present as a discontinuous material (e.g., a mesh, particles 110) on the conductive material 112. The group 6 metal 104 may be in direct contact with at least a portion of the conductive material 112, such as being directly on (e.g., attached to, secured to) the conductive material 112. In the anode-free electrochemical cells 100, 150, the conductive material 112 and the group 6 metal 104 may function in combination as the current collector 102 on the anode side of the electrochemical cell 100, 150. While not shown in FIGS. 1A and 1B, a substrate (not shown) may be located below the current collector 102.

The group 6 metal 104 may be a metal foil or a metal film that substantially contacts (e.g., covers) the current collector 102, as shown in FIG. 1A, and limits physical contact (e.g., direct contact) between the conductive material 112 and the electrolyte 106 of the electrochemical cell 100. The group 6 metal 104 may be a molybdenum foil, a tungsten foil, or a chromium foil. For example, the group 6 metal 104 may occupy greater than about 95% of the area (e.g., surface area) of the conductive material 112, such as about 100% of the area of the conductive material 112. The group 6 metal 104, therefore, extends substantially continuously over the conductive material 112 with no pinholes or voids present. As a result, the current generated by the electrochemical cell 100 during use and operation may pass through the group 6 metal 104 and into the conductive material 112 of the current collector 102. While FIG. 1A shows the group 6 metal 104 as being a single material on the conductive material 112, the current collector 102 may include multiple (e.g., more than one) films or foils of the group 6 metal 104.

Other configurations of the group 6 metal 104 are also possible if a degree of physical contact between the conductive material 112 and the electrolyte 106 is desired, as shown in the electrochemical cell 150 of FIG. 1B. For example, the group 6 metal 104 may occupy less than about 95% of the area (e.g., surface area) of the surface of the conductive material 112, such as from about 10% of the area of the conductive material 112 to less than about 95% of the area of the conductive material 112. The group 6 metal 104 on the conductive material 112 may be discontinuous, having multiple openings, which enable the electrolyte 106 to pass through the group 6 metal 104 and contact the conductive material 112 directly. The group 6 metal 104 may, for example, be configured as particles 110 or as a mesh on (e.g., attached to) the current collector 102. The group 6 metal 104 may, for example, be a molybdenum mesh, a tungsten mesh, a chromium mesh, molybdenum particles (e.g., molybdenum nanoparticles), tungsten particles (e.g., tungsten nanoparticles), or chromium particles (e.g., chromium nanoparticles).

Boundaries of the openings may be defined by surfaces of the group 6 metal 104. The group 6 metal 104 may occupy from about 10% to about 95% of the area (e.g., surface area) of the conductive material 112, such as from about 10% to about 90% of the area of the conductive material 112, from about 10% to about 80% of the area of the conductive material 112, from about 10% to about 70% of the area of the conductive material 112, from about 10% to about 60% of the area of the conductive material 112, from about 10% to about 50% of the area of the conductive material 112, from about 20% to about 90% of the area of the conductive material 112, from about 30% to about 90% of the area of the conductive material 112, from about 40% to about 90% of the area of the conductive material 112, from about 50% to about 90% of the area of the conductive material 112, from about 60% to about 90% of the area of the conductive material 112, from about 70% to about 90% of the area of the conductive material 112, or from about 80% to about 90% of the area of the conductive material 112. The openings may occupy the remaining area of the conductive material 112, such as from about 10% to about 90% of the area of the conductive material 112. In some embodiments, the openings include greater than about 90% of the area of the current collector 102, with the group 6 metal 104 occupying about 10% of the area of the conductive material 112.

The openings may be widespread, so as to form the mesh of the group 6 metal 104, for example. The mesh may include the openings occupying greater than about 90% of the area of the conductive material 112, with the group 6 metal 104 occupying about 10% of the area of the conductive material 112. However, the mesh may also include a greater percentage of the group 6 metal 104.

Alternatively, the openings may occupy a more limited portion of the surface area of the current collector 102, as shown in FIG. 1B, with the surfaces of the particles 110 (e.g., nanoparticles, mesoparticles) of the group 6 metal 104 defining boundaries of the openings. For example, the openings may occupy about 10% of the area of the conductive material 112, with the group 6 metal 104 in the form of the particles 110 occupying about 90% of the area of the conductive material 112. The particles 110 may be substantially uniformly dispersed on the surface of the conductive material 112 or may be randomly dispersed on the surface of the conductive material 112. The particles 110 may include molybdenum particles, tungsten particles, chromium particles, or a combination thereof. The use of the particles 110 (e.g., nanoparticles, mesoparticles) helps lower the weight and/or cost of the electrochemical cell 150, for example, compared with the use of the foil or other continuous configuration of the group 6 metal 104 in the electrochemical cell 100.

The particles 110 of the group 6 metal 104 may be configured in a variety of shapes or geometries. While the particles 110 are illustrated as being elliptical in FIG. 1B, the particles 110 may be configured as plates, chips, spheres, strips, wires, spindles, clumps, filaments, and/or another suitable geometry of the group 6 metal 104. The particles 110 may have a largest dimension on the order of about 1 millimeter in length and may be monodisperse or polydisperse. The particles 110 may also include a combination of group 6 metal particles 110. For example, the particles 110 may be a mixture of chromium particles and molybdenum particles. The use of particles 110 of multiple group 6 metals 104 may allow for a polydispersed mixture of particles with different sizes and/or shapes, in addition to the different group 6 metals. The particles 110 of one group 6 metal 104 may, for example, be nanoparticles with a first shape and a first size distribution and the particles 110 of a second, different group 6 metal 104 may be nanoparticles with a second shape and a second size distribution.

In addition to enabling the electrolyte 106 to pass through the group 6 metal 104, the openings may provide access for deposited alkali metal (e.g., lithium) from the electrolyte 106 to secure the group 6 metal 104 to the conductive material 112 of the current collector 102 during use and operation of the electrochemical cell 150. The openings of the mesh or between the particles 110 may facilitate attachment of the group 6 metal 104 to the conductive material 112 using the deposited alkali metal. The openings of the mesh or between the particles 110 may also provide a high degree of symmetry on the current collector 102 and, therefore, improve uniformity of deposition of the alkali metal onto the conductive material 112 and/or the group 6 metal 104. The openings may provide the uniformity to the current collector 102 without adding weight to the electrochemical cell 150, as would occur with the film or the foil configurations of the electrochemical cell 100.

As illustrated in FIGS. 1A and 1B, the anode-free electrochemical cells 100, 150 lack an active material as an anode prior to the initial cycling of the electrochemical cell 100, 150, which simplifies the configuration of the electrochemical cells 100, 150. On the anode side of the electrochemical cell circuit, the anode-free electrochemical cell 100, 150 initially includes the current collector 102 decorated with the group 6 metal 104. The current collector 102 serves to route the current during use and operation of the electrochemical cell 100, 150, providing an electrical connection for the anodic side of the electrochemical cell 100, 150. The current collector 102 becomes coated with the alkali metal (e.g., lithium) during the initial cycles of the electrochemical cell 100, 150. The anode-free electrochemical cell 100, 150 may, therefore, not have a reactive material on the current collector 102 until the current collector 102 is charged for the first time.

The group 6 metal 104 may be an elemental metal or a combination of elemental metals. The group 6 metal 104 on the conductive material 112 may, therefore, be substantially free of chemical compounds of the group 6 metal 104, such as being substantially free of a carbide compound, an oxide compound, a nitride compound, a selenide compound, a sulfide compounds, or a telluride compound of the group 6 metal 104. The group 6 metal 104 may be selected to be alkali metal philic (e.g., lithophilic, lithium philic). The group 6 metal 104 may include molybdenum (e.g., elemental molybdenum), chromium (e.g., elemental chromium), tungsten (e.g., elemental tungsten), or a combination thereof. In some embodiments, the group 6 metal 104 is elemental molybdenum. In other embodiments, the group 6 metal 104 is elemental chromium or elemental tungsten. In some embodiments, the group 6 metal 104 includes molybdenum particles. In other embodiments, the group 6 metal 104 includes a chromium mesh. In yet other embodiments, the group 6 metal 104 includes tungsten particles. In still other embodiments, the group 6 metal 104 includes a tungsten foil.

The conductive material 112 (e.g., the electrically conductive material 112) of the current collector 102 may be formed of and include a carbon material, a chromium material, a copper material, a molybdenum material, a tungsten material, an iron material (e.g., a stainless steel material), or a combination thereof. The conductive material 112 may be free standing or may include a conductive film or a conductive mesh on a substrate, such as on a polymer substrate. The current collector 102 may, therefore, include the group 6 metal 104 and the conductive material 112 on a polymer substrate. The conductive material 112 may, for example, be copper or a carbon-based material, such as a graphite-based or a nanotube-based material. In some embodiments, the conductive material 112 is a copper conductive material 112. In other embodiments, the conductive material 112 is a conductive carbon material. The conductive material 112 may be positioned opposite the cathode 108 such that the conductive material 112 and the cathode 108 are connected by (e.g., electrically connected by) the electrolyte 106. The cathode 108 may be separated from the group 6 metal 104 by the electrolyte 106.

In some embodiments, the current collector 102 includes a copper film as the conductive material 112 and the group 6 metal 104 is a molybdenum film on the surface of the copper film. In other embodiments, the current collector 102 is a conductive carbon material with molybdenum particles as the group 6 metal 104 on the surface of the conductive carbon material. In yet other embodiments, the current collector 102 includes a copper film as the conductive material 112 and the group 6 metal 104 is a chromium film.

If the group 6 metal 104 is configured as the particles 110 (e.g., nanoparticles, mesoparticles), the particles 110 may be formed on the conductive material 112 by conventional techniques. Alternatively, the particles 110 may be available from commercial suppliers and applied to the conductive material 112 by conventional techniques. If the group 6 metal 104 is configured as the film, foil, or mesh, the film, foil, or mesh may be applied to the conductive material 112 by conventional techniques. Commercial suppliers are also available for films, foils, and meshes of the group 6 metal 104.

The electrolyte 106 may be selected to include the alkali metal to be deposited and stripped during use and operation of the electrochemical cell 100, 150. The electrolyte 106 may include a low-concentration electrolyte or a high-concentration electrolyte (such as 4 mol/L lithium bis(fluorosulfonyl)imide (LiFSI) in dimethoxyethane (DME)). The low-concentration electrolyte may include a concentration of less than about 4 mol/L and the high-concentration electrolyte may include a concentration greater than or equal to about 4 mol/L. The electrolyte 106 may be a localized high-concentration electrolyte (LHCE), such as LiFSI in DME with diluents. The electrolyte 106 may include, for example, LiFSI, lithium bis(trifluoromethanesulfonyl) imide (LiTFSI) in dioxolane (DOL) and dimethoxyethane (DME) with lithium nitrate (LiNO₃). Alternatively, the electrolyte 106 may include lithium hexafluorophosphate (LiPF₆) in ethylene carbonate (EC) and ethyl methyl carbonate (EMC) with fluoroethylene carbonate (FEC) and/or vinylene carbonate (VC). Other electrolytes are available in the art and may be used as the electrolyte 106. Accordingly, the described electrochemical cells 100, 150 are not limited to a particular electrolyte 106 or cathode 108. Therefore, the current collectors 102 according to embodiments of the disclosure may be used with new electrolytes and cathode materials in the electrochemical cells 100, 150.

The cathode 108 may include any of the cathodic materials known in the art. For example, the cathode 108 may include air (O₂), a sulfide, a metal oxide (such as nickel-manganese-cobalt oxide (NMC), lithium nickel cobalt aluminum oxide (NCA), lithium manganese oxide (LMO), lithium iron phosphate (LiFePO₄), lithium cobalt oxide (LiCoO₂), lithium titanate (Li₂TiO₃)), or a combination thereof. In some embodiments, the cathode 108 is an NMC composition. The cathode material may, for example, be NMC333, NMC622, NMC811, or NMC955. With NMC compositions, the numbers represent the proportions of the nickel, manganese, and cobalt respectively. For instance, NMC333 has equal parts nickel, manganese, and cobalt. NMC622 includes sixty percent nickel, twenty percent manganese, and twenty percent cobalt. NMC811 includes eighty percent nickel, ten percent manganese, and ten percent cobalt. NMC955 includes ninety percent nickel, five percent manganese, and five percent cobalt. These electrodes cover a wide range of nickel, manganese, and cobalt concentrations. In some embodiment, the cathode is NMC622 (LiNi_{0.6}Mn_{0.2}Co_{0.2}O₂). A variety of NMC-type cathodes are suitable for use with the described electrochemical cells 100, 150.

To form the electrochemical cells 100, 150 having the current collector 102 according to embodiments of the disclosure, the group 6 metal 104 is formed on the surface of the conductive material 112 by conventional techniques. For example, physical vapor deposition (PVD), chemical vapor deposition (CVD), plating of the surface of the conductive material 112 with the particles 110, or physical (i.e., mechanical) forming of the group 6 metal 104 on the conductive material 112 may be used. Physical forming of the group 6 metal 104 on the conductive material 112 may include mechanical attachment of the group 6 metal 104 to the conductive material 112. For instance, the film of the group 6 metal 104 may be swaged, crimped, or otherwise mechanically connected to the conductive material 112. The film may be mechanically connected to provide an electrical connection between the group 6 metal 104 and the conductive material 112 of the current collector 102. The formation of the group 6 metal 104 may avoid using thermal processes to limit the formation of an oxide on the group 6 metal 104.

The electrolyte 106 may be formed (e.g., assembled) on the group 6 metal 104 and the cathode 108 may be formed on the electrolyte 106 by conventional techniques. In some embodiments, the current collector 102 is assembled with the electrolyte 106 and the cathode 108 to form the electrochemical cell 100, 150. The electrochemical cell 100, 150 may, for example, be assembled using the conductive material 112 of the current collector 102 as a base, with the group 6 metal 104, 110 applied to the current collector 102. The electrolyte 106 may be applied onto the current collector 102 and the cathode 108. The electrolyte 106 on the current collector 102 and the electrolyte 106 on the cathode 108 may then be combined, with the electrolyte 106 merging to form a single, combined layer of electrolyte 106.

After forming the group 6 metal 104, the group 6 metal 104 may be subject to cleaning before forming the electrolyte 106 and the cathode 108 of the electrochemical cell 100, 150. Alternatively, the group 6 metal 104 may be cleaned prior to placement in the electrochemical cell 100, 150. In one example, the group 6 metal 104 may be subjected (e.g., exposed) to sulfuric acid (H₂SO₄), such as to a dilute sulfuric acid solution, as part of the cleaning process. Alternatively, the group 6 metal 104 may be subjected to cleaning with an organic solvent with ultrasonic agitation. For example, the group 6 metal 104 may be subjected to an alcohol (e.g., isopropanol) soak, followed by removing (e.g., blowing off) the excess alcohol using filtered air. For example, the group 6 metal 104 may be cleaned with acetone and/or another organic solvent prior to forming the electrochemical cell 100, 150.

Alternatively, the electrochemical cell 100, 150 is formed with a so-called “jelly roll” configuration where the electrolyte 106 is formed and then the conductive material 112, the group 6 metal 104, the electrolyte 106, and the cathode 108 are rolled together to form a roll having the current collector 102 and cathode 108 separated by layers of the electrolyte 106, with the group 6 metal 104, 110 between the conductive material 112 and the electrolyte 106. In such an embodiment, the conductive material 112 may be formed of and include a metal film capable of being rolled to form the described geometry. The cathode 108 may extend from one end of the roll and the current collector 102 extends from the other end of the roll, providing the ability to contact both sides of the electrochemical cell 100, 150.

During use and operation of the anode-free, electrochemical cell 100, 150 illustrated in FIGS. 1A, 1B, the alkali metal from the electrolyte 106 is deposited on the current collector 102 during the charge cycle and the alkali metal is stripped from the current collector 102 during the discharge cycle. The current collector 102, therefore, is plated with the alkali metal during the charge cycle. During the discharge cycle, the plated alkali metal is desorbed from the surface of the current collector 102 and returned to the electrolyte 106, with the charge and discharge cycles being conducted repeatedly. Without being bound by any theory, it is believed that the group 6 metal 104 on the surface of the current collector 102 influences the plating of the alkali metal onto the current collector 102. The group 6 metal 104 on the current collector 102 improves the uniformity of deposited alkali metal onto the current collector 102. The group 6 metal 104 is also believed to reduce the tendency of the alkali metal to deposit as dendrites. The presence of the group 6 metal 104 is also believed to reduce the tendency of the alkali metal to deposit as inactive or so-called “dead” alkali metal on the current collector 102, such as depositing as metal that does not plate onto or redissolve from the current collector 102. The inactivated alkali metal is not able to contribute to energy storage of the electrochemical cell 100, 150. The group 6 metal 104 also reduces overpotential applied to the current collector 102 while charging the electrochemical cell 100, 150. Therefore, the anode-free electrochemical cell 100, 150 according to embodiments of the disclosure may be simpler to implement than conventional electrochemical cells which include an electrochemically active anode.

If, for example, the energy storage device is a lithium ion battery and the group 6 metal 104 is molybdenum, the anode-free, electrochemical cells 100, 150 use the current collector 102, which is plated with lithium from a lithium-based electrolyte 106, during the charge/discharge cycle. Lithium is deposited on the group 6 metal 104 or on the conductive material 112 and the group 6 metal 104 of the current collector 102 during the charge cycle, and is stripped from the group 6 metal 104 or from the conductive material 112 and the group 6 metal 104 of the current collector 102 during the discharge cycle. The molybdenum of the group 6 metal 104 is believed to make the deposition of lithium from the electrolyte 106 onto the current collector 102 more uniform and reduce inactive lithium formation. The molybdenum also reduces dendrite formation during deposition of the lithium and reduces the overpotential applied to the current collector 102. While not wishing to be bound by any theory, it is believed that the lithophilic nature of the molybdenum contributes to the formation of the functional lithium deposition and limits the dendrite formation. Using the molybdenum as the group 6 metal 104 of the current collector 102 may guide uniform lithium nucleation in order to reduce lithium dendrite growth, modify lithium formation due to reduced lithium nucleation overpotential, and provide good wettability of lithium on molybdenum. If the group 6 metal 104 includes molybdenum particles, the molybdenum particles at the surface of the current collector 102 may help induce more uniform lithium plating and/or stripping morphologies with reduced overpotential, reduced dendrite growth, and/or reduced inactive lithium formation.

The following examples serve to further illustrate embodiments of the disclosure in more detail. These examples are not to be construed as being exhaustive or exclusive as to the scope of this disclosure.

### EXAMPLES

### Example 1 Current Collector Formation

The current collector included a copper conductive material and a cleaned molybdenum foil as the group 6 metal. The foil was sourced from a commercial vendor (Alfa Aesar™, 0.1 mm thickness). The foil was subject to a sulfuric acid clean prior to use for 5 minutes at room temperature and 1 mol/L concentration. The foil was rinsed three times in deionized water (DI water) for 5 minutes at room temperature. The foil was attached to the copper conductive material on the anode side of the electrochemical cell. An electrochemical cell including the copper conductive material, the molybdenum foil, NMC811 as the cathode, and 1.2 M LiPF₆ in 3:7 wt. % EC:EMC + 10 wt. % VC as the electrolyte was prepared. Additional electrochemical cells including a lithium anode, a copper current collector, and a zinc decorated current collector, in place of the molybdenum foil, were also prepared.

The electrochemical cells were connected to a potentiostat/galvanostat to cycle the electrochemical cells. The potentiostat/galvanostat was used to charge the electrochemical cells and discharge the electrochemical cells while monitoring the current and/or potential applied at the current collector and cathode. The charge capacity, i.e., how much charge could a given electrochemical cell produce/discharge and columbic efficiency, i.e., how efficient was the charging operation, were the outputs of the testing. With each cycle, an amount of charge required to charge the electrochemical cell 100, 150 and the efficiency of charging is recorded.

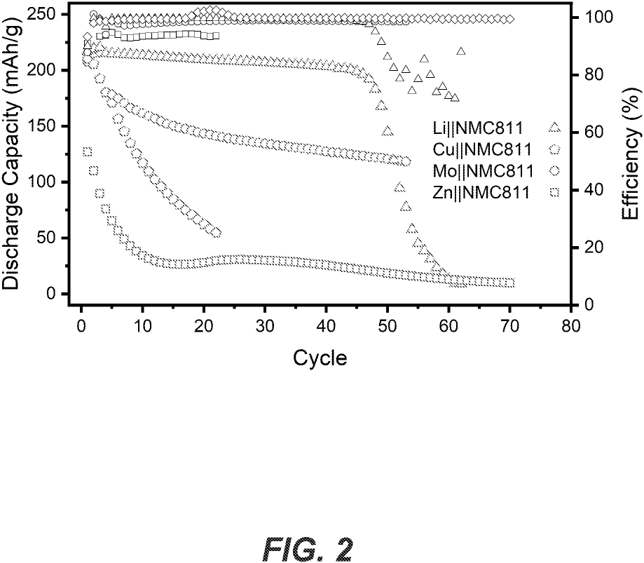

FIG. 2 shows the specific discharge capacity (left side scale) and columbic efficiencies (CEs) (right side scale) vs. cycle numbers for the tested electrochemical cell. The electrochemical cell with the lithium anode is shown as a solid triangle, the electrochemical cell with the copper current collector is shown as a solid square, the electrochemical cell with the molybdenum decorated current collector is shown as a solid circle, and the electrochemical cell with the zinc decorated current collector is shown as a solid diamond. In this testing, the molybdenum decorated current collector is the only tested electrochemical cell with the group 6 metal present. The electrochemical cells including the lithium anode and copper current collector were used as comparative examples. CE was shown with the outlined shapes. The electrochemical cell with the lithium anode showed stable charge capacity and coulombic efficiency due to sufficient lithium inventory and the electrochemical cell decayed significantly after ~ 45 cycles due to electrolyte loss. However, for the anode-free electrochemical cells, the molybdenum decorated current collector was next best in charge capacity and was slowly decreasing in charge capacity over more than 50 cycles. The copper current collector showed lower charge capacity than the molybdenum decorated current collector, while the zinc decorated current collector had a charge capacity lower than the other materials (Cu, Mo, and Li).

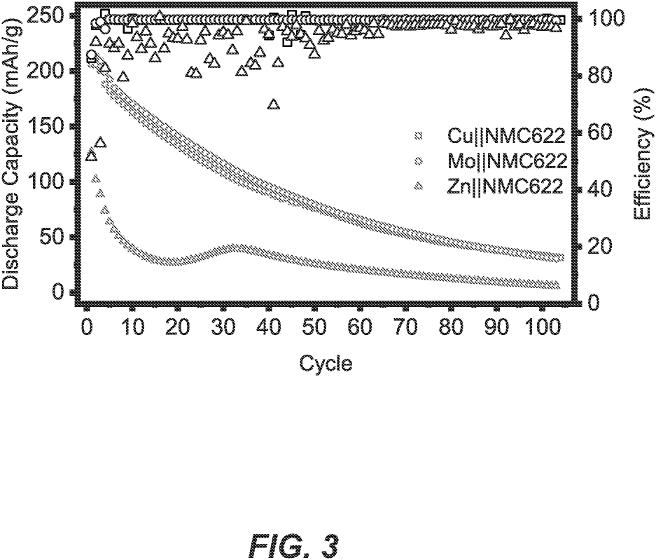

FIG. 3 shows the specific discharge capacity and CEs vs. cycle numbers for a lithium anode, a copper current collector, a molybdenum decorated current collector, and a zinc decorated current collector in a secondary electrochemical cell setup with an ether-based electrolyte in accordance with embodiments of the disclosure. The second tested electrochemical cell setup used a NMC622 cathode and 1 M LiFSI in 1:9 DME:TFEO (LHCE) as the electrolyte. The copper current collector is a light green color square, the molybdenum decorated current collector is a black square, and zinc decorated current collector is a pink square. The molybdenum decorated current collector slightly outperformed the copper current collector in discharge capacity and both molybdenum and copper significantly outperformed zinc as a current collector in terms of discharge capacity. The outlined shapes correspond to the efficiency measurements on the right side scale, with the triangles corresponding to the zinc decorated current collector efficiency, the circles corresponding to the molybdenum decorated current collector efficiency, and the squares corresponding to the copper current collector efficiency. The zinc decorated current collector had notably lower efficiency compared with the other cell configurations, with the copper current collector also showing some inconsistency in efficiency. The molybdenum decorated current collector had a consistent, high efficiency of about 100%.

### Example 2 Characterization of Current Collectors

Cycling tests were performed in accordance with conventional techniques. To obtain the cycling performances, galvanostatic cycling was performed with a MACCOR Model 2200 (Maccor, Inc.). The cycling tests were performed at room temperature with the compositions described below.

Two cathode materials were used, NMC811 and NMC622. These materials are nickel-rich mixtures of manganese and cobalt. The impact of the different cathode materials was believed to be minimal and differences in the two setups were believed to be primarily a function of the anode side and/or the electrolyte used.

The electrolytes used included 1.2 M LiPF₆ in 3:7 wt. % EC:EMC + 10 wt% VC. EC is ethylene carbonate, EMC is ethyl-methyl carbonate, and VC is vinylene carbonate. Another electrolyte used was 1 M LiFSI in 1:9 DME:TFEO (LHCE). LiFSI is lithium bis(fluorosulfonyl)imide, DME is dimethoxyethane, and TFEO is tris(2,2,2-trifluoroethyl) orthoformate. LHCE stands for Localized High Concentration Electrolyte.

The fabricated electrochemical cells were cycled with a charge/discharge cycle between about 4.4 volts and about 2.8 volts. By cycle ten, there was a clear difference in charge capacity. The molybdenum decorated current collector outperformed the copper current collector and the lithium metal anode outperformed the molybdenum decorated current collector.

Although the foregoing descriptions contain many specifics, these are not to be construed as limiting the scope of the disclosure, but merely as providing certain exemplary embodiments. Similarly, other embodiments of the disclosure may be devised that do not depart from the scope of the disclosure. For example, features described herein with reference to one embodiment may also be provided in others of the embodiments described herein. The scope of the embodiments of the disclosure is, therefore, indicated and limited only by the appended claims and their legal equivalents, rather than by the foregoing description. All additions, deletions, and modifications to the disclosure, as disclosed herein, which fall within the meaning and scope of the claims, are encompassed by the disclosure.

What is claimed is:

1. A current collector comprising:
a conductive material; and
an elemental metal of a group 6 metal contacting the conductive material.

2. The current collector of claim 1, wherein the elemental metal of the group 6 metal comprises a film, a foil, a sheet, a mesh, or particles.

3. The current collector of claim 1, wherein the conductive material comprises a metal or a conductive carbon.

4. The current collector of claim 1, wherein the elemental metal of the group 6 metal comprises a molybdenum film, molybdenum particles, or a molybdenum mesh.

5. The current collector of claim 1, wherein the elemental metal of the group 6 metal comprises a chromium film, chromium particles, or a chromium mesh.

6. The current collector of claim 1, wherein the elemental metal of the group 6 metal comprises a tungsten film, tungsten particles, or a tungsten mesh.

7. An electrochemical cell comprising:
a current collector comprising a group 6 metal on a conductive material;
a cathode adjacent to the current collector; and
an alkali metal-based electrolyte between the current collector and the cathode, the cathode separated from the group 6 metal by the alkali metal-based electrolyte.

8. The electrochemical cell of claim 7, wherein the group 6 metal is on a side of the electrochemical cell opposite the cathode.

9. The electrochemical cell of claim 7, wherein the group 6 metal comprises a continuous material on the conductive material.

10. The electrochemical cell of claim 7, wherein the group 6 metal comprises a discontinuous material on the conductive material.

11. The electrochemical cell of claim 7, wherein the group 6 metal comprises an elemental group 6 metal.

12. The electrochemical cell of claim 7, wherein the alkali metal-based electrolyte directly contacts at least a portion of the group 6 metal.

13. The electrochemical cell of claim 7, wherein the alkali metal-based electrolyte directly contacts the conductive material of the current collector.

14. The electrochemical cell of claim 7, wherein the electrochemical cell is anode-free.

15. The electrochemical cell of claim 7, wherein the electrochemical cell is configured as an alkali metal ion battery.

16. A method of operating an electrochemical cell, comprising:
forming an electrochemical cell comprising a current collector comprising a conductive material and a group 6 metal thereon, an alkali metal-based electrolyte on the current collector, and a cathode on the electrolyte;
cycling the electrochemical cell to form the alkali metal on the current collector; and
discharging the electrochemical cell to remove the alkali metal from the current collector.

17. The method of claim 16, wherein cycling the electrochemical cell to form the alkali metal on the current collector comprises forming the alkali metal on the group 6 metal of the current collector.

18. The method of claim 16, wherein cycling the electrochemical cell to form the alkali metal on the current collector comprises substantially uniformly depositing the alkali metal on the current collector.

19. The method of claim 16, wherein cycling the electrochemical cell to form the alkali metal on the current collector comprises forming the alkali metal on the conductive material of the current collector.

20. The method of claim 16, wherein discharging the electrochemical cell to remove the alkali metal from the current collector comprises desorbing the alkali metal from the current collector and into the alkali metal-based electrolyte.
